(19) United States
(12) Patent Application Publication
(10) Pub. No.: US 2023/0132193 A1
(43) Pub. Date: Apr. 27, 2023

(54) IMAGE CAPTURING DEVICE, IMAGE CAPTURING SYSTEM, AND IMAGE CAPTURING METHOD

(71) Applicant: SONY SEMICONDUCTOR SOLUTIONS CORPORATION, KANAGAWA (JP)

(72) Inventors: MASATOSHI SUZUKI, TOKYO (JP); TOMOHIRO YAMAZAKI, KANAGAWA (JP)

(21) Appl. No.: 17/906,667

(22) PCT Filed: Mar. 18, 2021
(86) PCT No.: PCT/JP2021/011076

§ 371 Date: Sep. 19, 2022

(30) Foreign Application Priority Data
Mar. 30, 2020 (JP) 2020-061581

(51) Int. Cl. H04N 23/63; H04N 23/20

(52) U.S. Cl. CPC H04N 23/633; H04N 23/20

(57) ABSTRACT

An image capturing device (100) includes an image capturing unit (110), an acquisition unit (131), an additional information imparting unit (132), and an output unit (133). The image capturing unit (110) extends straight in a longitudinal direction. The acquisition unit (131) acquires line data from the image capturing unit (110). The additional information imparting unit (132) imparts first additional information to the line data that is a head line of a frame out of a plurality of the line data to generate output line data. The output unit (133) outputs the output line data.

### TECHNICAL FIELD

The present disclosure relates to an image capturing device, an image capturing system, and an image capturing method.

### BACKGROUND ART

A technology to impart additional information to a captured image and outputting the image is known in order to display the image captured by an image capturing device on a display device (see, for example, Patent Document 1). With such a technology, by imparting additional information such as a start code indicating a line head to each line of the captured image, the image capturing device outputs the captured image including information such as the line start position.

### CITATION LIST

### Patent Document

Patent Document 1: Japanese Patent Application Laid-Open No. 2012-120159

### SUMMARY OF THE INVENTION

### Problems to be Solved by the Invention

However, in a case where the image capturing device is, for example, a line sensor that sequentially captures a moving object to be measured in each predetermined region, although it is possible to determine the line head only with the start code indicating the line head, it is difficult to determine a frame head. Therefore, for example, an external control device that controls the image capturing device needs to detect the frame head from the captured image, and there is a problem that the processing of the control device increases.

Therefore, the present disclosure provides an image capturing device, an image capturing system, and an image capturing method that can reduce the processing of the external control device.

### Solutions to Problems

The present disclosure provides an image capturing device. The image capturing device includes an image capturing unit, an acquisition unit, an additional information imparting unit, and an output unit. The image capturing unit extends straight in the longitudinal direction. The acquisition unit acquires line data from the image capturing unit. The additional information imparting unit imparts first additional information to the line data that is a head line of a frame out of a plurality of the line data to generate output line data. The output unit outputs the output line data.

### BRIEF DESCRIPTION OF DRAWINGS

FIG. 1 is a diagram for describing image acquisition processing using a line sensor.

FIG. 2 is a diagram for describing the overview of the image acquisition processing with an image capturing system according to an embodiment of the present disclosure.

FIG. 3 is a block diagram showing a configuration example of the image capturing system according to the embodiment of the present disclosure.

FIG. 4 is a block diagram showing a configuration example of the line sensor according to the embodiment of the present disclosure.

FIG. 5 is a diagram for describing an arrangement example of unit pixels included in an image capturing unit according to the embodiment of the present disclosure.

FIG. 6 is a diagram for describing the image capturing unit of an area sensor.

FIG. 7 is a diagram for describing image acquisition processing by an image capturing system according to a comparative example.

FIG. 8 is a diagram for describing the image acquisition processing by the image capturing system according to the embodiment of the present disclosure.

FIG. 9 is a diagram for describing an operation example of the image capturing system according to the comparative example.

FIG. 10 is a diagram for describing control signals generated by a control device according to the comparative example.

FIG. 11 is a diagram for describing an operation example of the image capturing system according to the embodiment of the present disclosure.

FIG. 12 is a diagram for describing control signals generated by a control device according to the embodiment of the present disclosure.

FIG. 13 is a diagram for describing a register control signal generated by the control device according to the embodiment of the present disclosure.

FIG. 14 is a diagram for describing a frame control signal generated by the control device according to the embodiment of the present disclosure.

FIG. 15 is a diagram for describing another example of the register control signal generated by the control device according to the embodiment of the present disclosure.

FIG. 16 is a flowchart showing one example of line data output processing by the line sensor according to the embodiment of the present disclosure.

### MODE FOR CARRYING OUT THE INVENTION

A preferred embodiment of the present disclosure will be described in detail below with reference to the accompanying drawings. Note that in the present specification and the drawings, components having substantially the same functional configuration are denoted with the same reference symbol, and redundant description thereof will be omitted.

Note that the description will be made in the following order.

1. Preface

2. Image capturing system

2.1. Overview of image capturing system

2.2. Configuration example of image capturing system

2.3. Configuration example of line sensor

3. Operation example of image capturing system

3.1. Image acquisition processing

3.2. Operation example of image capturing system

3.3. Operation example of line sensor

4. Supplement

### 1. Preface

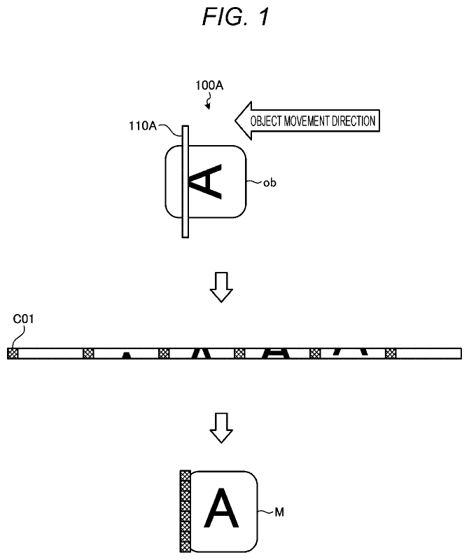

To begin with, an overview of acquisition processing for acquiring an image of an object by using a line sensor will be described. FIG. 1 is a diagram for describing image acquisition processing using a line sensor.

As shown in the upper figure of FIG. 1, a line sensor 100A includes an image capturing unit 110A including a plurality of pixels arranged to extend straight in a longitudinal direction. In the upper figure of FIG. 1, an object ob moves from right to left, and the line sensor 100A sequentially captures images of the moving object ob in a predetermined cycle. Upon capturing images of the moving object ob with the image capturing unit 110A, the line sensor 100A generates line data and outputs the line data to a control device 200A (not shown). At this time, the line sensor 100A imparts additional information to the line data and outputs the line data. The additional information is, for example, a control signal, a fixed value parameter, and the like. Hereinafter, such additional information is also described as a synchronizing code. In the middle figure of FIG. 1, the line sensor 100A imparts a head code C01 indicating the head of the line data (one example of additional information) to the head of the line data as the synchronizing code, and output the line data.

Upon acquiring the line data from the line sensor 100A, as shown in the lower figure of FIG. 1, with reference to the synchronizing code of the line data, the control device 200A generates image data M to be displayed on a display device 300A (not shown).

At this time, only the synchronizing code indicating the data head is imparted to the line data output from the line sensor 100A. Therefore, the control device 200A needs to determine from which line data to which line data is defined as one frame with reference to pixel values of the line data and the like. In the image acquisition processing by the conventional line sensor 100A, the processing load of the control device 200A is high. Therefore, the line sensor 100A that can reduce the processing load of the control device 200A has been desired.

### 2. Image Capturing System

### 2.1. Overview of Image Capturing System

Therefore, in the image capturing system according to the embodiment of the present disclosure, the line sensor imparts the synchronizing code indicating the frame head (one example of first additional information) to the line data that is the head line of the frame. This allows the control device to determine which line data is to be processed as one frame without referring to the pixel values of the line data, allowing reduction in the processing load of the control device.

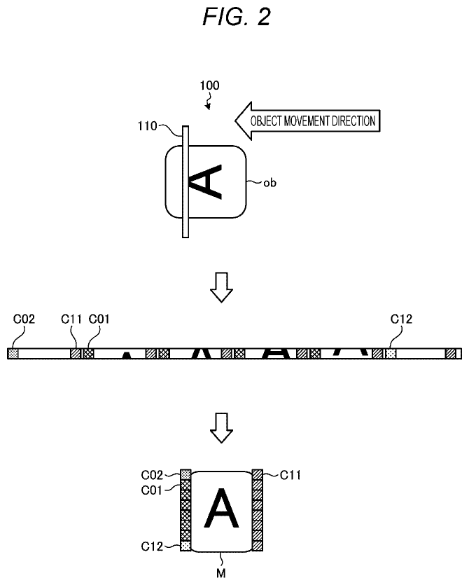

With reference to FIG. 2, the overview of image acquisition processing with the image capturing system according to the present embodiment will be described. FIG. 2 is a diagram for describing the overview of the image acquisition processing with the image capturing system according to the embodiment of the present disclosure. The image capturing system includes a line sensor 100, a control device 200 (not shown), and a display device 300 (not shown), and displays images captured by the line sensor 100 on the display device 300.

As shown in the upper figure of FIG. 2, the line sensor 100 includes an image capturing unit 110 including a plurality of pixels arranged to extend straight in a longitudinal direction. In the upper figure of FIG. 2, an object ob moves from right to left, and the line sensor 100 sequentially captures images of the moving object ob in a predetermined cycle.

As shown in the middle figure of FIG. 2, the line sensor 100 imparts a synchronizing code to captured line data to generate output line data. At this time, the line sensor 100 imparts the line head code C01 indicating the head of the line data as the synchronizing code. Moreover, the line sensor 100 imparts a frame head code C02 indicating the head of the frame as the synchronizing code (one example of first additional information) to the line data that is the head line of the frame.

Note that in addition to the line head code C01 and the frame head code C02 described above, a line terminal code C11 indicating the terminus of the line data and a frame terminal code C12 indicating the terminal line of the frame (one example of second additional information) may be imparted to the line data shown in FIG. 2. Furthermore, a valid/invalid code C13 indicating whether or not the line data is valid data (not shown) (one example of third additional information) may be imparted.

Details of the synchronizing code to be imparted to the line data will be described later.

The line sensor 100 outputs the generated output line data to the control device 200. The control device 200 outputs, to the display device 300, data from the output line data to which the frame head code C02 is imparted to the line data to which the frame terminal code C12 is imparted as one frame with reference to the synchronizing code. This allows the display device 300 to display image data M of one frame as shown in the lower figure of FIG. 2.

Furthermore, the control device 200, which can determine the line data included in the frame by referring to the synchronizing code, does not need to refer to the pixel values of the line data and can reduce the processing load.

### 2.2. Configuration Example of Image Capturing System

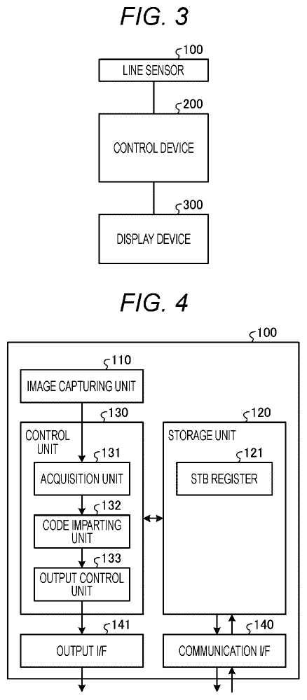

Subsequently, with reference to FIG. 3, a configuration example of the image capturing system according to the embodiment of the present disclosure will be described. FIG. 3 is a block diagram showing the configuration example of the image capturing system according to the embodiment of the present disclosure.

As shown in FIG. 3, the image capturing system according to the present embodiment includes the line sensor 100, the control device 200, and the display device 300.

The line sensor 100 is an image capturing device including the image capturing unit 110 (not shown) extending straight in the longitudinal direction (hereafter, also described as horizontal direction), and outputting the output line data line by line to the control device 200. Details of the line sensor 100 will be described later with reference to FIG. 4 and the like.

The control device 200 is a device that controls the entire image capturing system. The control device 200 includes, for example, a processor such as a central processing unit (CPU), a digital signal processor (DSP), and the like, a microcomputer equipped with these processors, or the like, and controls the operation of the line sensor 100 and the display device 300 by executing signal processing according to a predetermined program. The control device 200 generates display line data on the basis of the output line data acquired from the line sensor 100 and outputs the display line data to the display device 300.

The display device 300 is a display device that displays an image M on the basis of the display line data output by the control device 200. The display device 300 corresponds to, for example, a liquid crystal display, an organic electro luminescence (EL) display, a touch panel, and the like.

### 2.3. Configuration Example of Line Sensor

Subsequently, with reference to FIG. 4, a configuration example of the line sensor 100 according to the embodiment of the present disclosure will be described. FIG. 4 is a block diagram showing the configuration example of the line sensor 100 according to the embodiment of the present disclosure.

As shown in FIG. 4, the line sensor 100 according to the present embodiment includes the image capturing unit 110, a storage unit 120, a control unit 130, a communication I/F 140, and an output I/F 141.

(Image Capturing Unit 110)

The image capturing unit 110 includes a plurality of unit pixels 111 (hereinafter, also described as pixels) each including a photoelectric conversion element (not shown) that photoelectrically converts the amount of electric charge according to the amount of incident light, stores the electric charge inside, and outputs the electric charge as a signal.

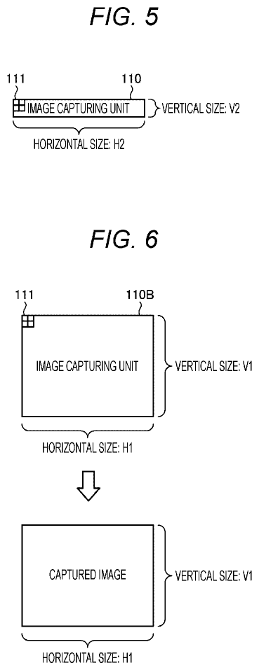

FIG. 5 is a diagram for describing an arrangement example of the unit pixels 111 included in the image capturing unit 110 according to the embodiment of the present disclosure. As shown in FIG. 5, the unit pixels 111 are arranged in a V2×H2 matrix. The size in the vertical direction (vertical size) V2 may be “1” or may be “1” or more as shown in FIG. 5. The horizontal direction corresponds to the above-described longitudinal direction, and the horizontal size H2 is longer than the vertical size V2.

Here, the image capturing device that captures an image of a predetermined region (area) and outputs the captured image of the captured region will be described with reference to FIG. 6. Such an image capturing device is also referred to as an area sensor as opposed to the line sensor 100. FIG. 6 is a diagram for describing an image capturing unit 110B of the area sensor.

As shown in FIG. 6, the image capturing unit 110B of the area sensor includes pixels 111 arranged in a V1×H1 matrix. Note that V1>V2 and H1−V1>H2−V2. The area sensor reads pixel signals from all the pixels of the image capturing unit 110B in one image capturing to generate pixel data. The area sensor outputs the pixel data obtained in one image capturing as one frame. The display device 300 displays the pixel data output by the area sensor as one captured image. Therefore, the display device 300 displays the captured image with the vertical size of V1 and the horizontal size of H1.

Note that the area sensor outputs the pixel data line by line with, for example, the synchronizing code imparted. The synchronizing code includes a code indicating the head of a line, and a code indicating the head or terminus of a frame. As described above, for the area sensor, the region of V1×H1 where the pixels are arranged is one frame. Therefore, the area sensor imparts a code indicating the frame head to the head line of the image capturing unit 110B, and imparts a code indicating the frame terminus to the last line. Such an area sensor does not output a region that is equal to or greater than the region that can be captured by the plurality of pixels 111 in one image capturing as one frame.

Meanwhile, in the line sensor 100 according to the present embodiment, as described above, the region that can be captured by the image capturing unit 110 is more elongated than the image capturing unit 110B of the area sensor. However, since the display device 300 displays the plurality of captured images captured by the image capturing unit 110 as one display image, the image capturing system can handle a region wider than the region that can be captured (H2×V3, V3>V2) as one image M.

(Communication I/F 140)

The description returns to FIG. 5. The communication I/F 140 is an interface to communicate with the control device 200. The communication I/F 140 may include a general purpose communication interface to communicate with an external device, or may include an external terminal to which a control signal from the control device 200 is input.

(Output I/F 141)

The output I/F 141 outputs the line data acquired by the line sensor 100 as the output line data. The output I/F 141 according to the present embodiment outputs the output line data to the control device 200.

(Storage Unit 120)

The storage unit 120 stores the captured image captured by the image capturing unit 110, and various data required for processing to be performed by the control unit 130 (for example, synchronizing code and the like). Furthermore, the storage unit 120 includes an STB register 121. The STB register 121 stores whether the line sensor 100 is in an active state in which capturing is possible or in a standby state in which capturing has stopped. The STB register 121 of the present embodiment causes the stored state to make a transition under the control of the control unit 130, and causes the state to make a transition under the control of the control device 200 as well. Details of such a point will be described later.

(Control Unit 130)

The control unit 130 controls the entire line sensor 100. The control unit 130 includes, for example, a control circuit, and controls the operation of the line sensor 100 by referring to internal parameters stored in the storage unit 120. Alternatively, the control unit 130 may include, for example, a processor such as a CPU or DSP, a microcomputer equipped with these processors, or the like, and may control the operation of the line sensor 100 by performing signal processing according to a predetermined program. The control unit 130 includes an acquisition unit 131, a code imparting unit 132, and an output control unit 133, and implements or executes functions and actions of information processing described below. Note that the internal configuration of the control unit 130 is not limited to the configuration shown in FIG. 5, and may be another configuration as long as the configuration performs information processing described later. Furthermore, the connection relationship of each part of the control unit 130 is not limited to the connection relationship shown in FIG. 5, and may be another connection relationship.

(Acquisition Unit 131)

The acquisition unit 131 acquires the captured image from the image capturing unit 110, generates the line data, and outputs the line data to the code imparting unit 132. Here, for example, in a case where the vertical size V2 of the image capturing unit 110 is 1 or more, the acquisition unit 131 may generate one line data by integrating a plurality of the captured images.

As described above, since the image capturing system captures images while moving the object ob, which is the object to be captured, one capturing time is shortened, and the luminance value of the captured image decreases as a whole. Therefore, the acquisition unit 131 inhibits the decrease in the luminance value of the captured image by integrating the pixel values of the pixels 111 in different lines obtained by capturing the same region of the object ob and generating one line data. In this way, the line sensor that integrates the captured images is also referred to as a time delay integration (TDI) line sensor.

(Code Imparting Unit 132)

The code imparting unit 132 imparts the synchronizing code to the line data output by the acquisition unit 131 to generate the output line data. The code imparting unit 132 outputs the generated output line data to the output control unit 133. The code imparting unit 132 imparts the frame head code C02 indicating the frame head to the head of the line data. Furthermore, the code imparting unit 132 imparts the frame terminal code C12 indicating the terminal line of the frame and the valid/invalid code C13 indicating whether or not the line data is valid data. Furthermore, the code imparting unit 132 imparts the line terminal code C11 indicating the terminus of the line data to the terminus of the line data.

Here, the valid data refers to, for example, data obtained by integrating the captured images of a predetermined number of pixel lines in a case where the acquisition unit 131 integrates the captured images of the plurality of pixel lines. Meanwhile, the invalid data that is not valid data refers to data obtained by integrating the captured images of the number of pixel lines less than the predetermined number. The valid data is displayed on the display device 300 or used for subsequent image processing such as subject detection, for example.

The code imparting unit 132 imparts the frame head code C02 and the frame terminal code C12 on the basis of the control signal of the control device 200.

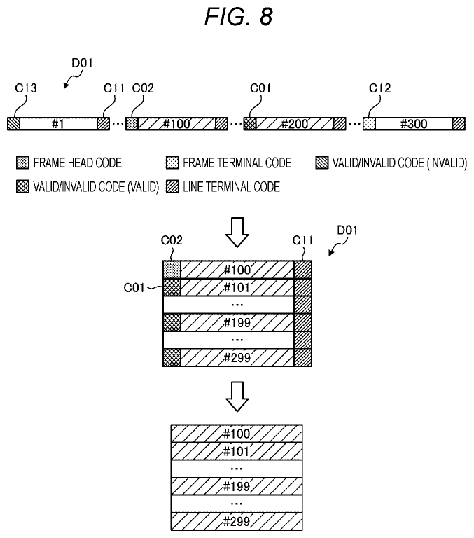

Note that details of the synchronizing code imparted by the code imparting unit 132 will be described later with reference to FIG. 8.

(Output Control Unit 133)

The output control unit 133 outputs the output line data generated by the code imparting unit 132 to the control device 200 via the output I/F 141.

### 3. Operation Example of Image Capturing System

### 3.1. Image Acquisition Processing

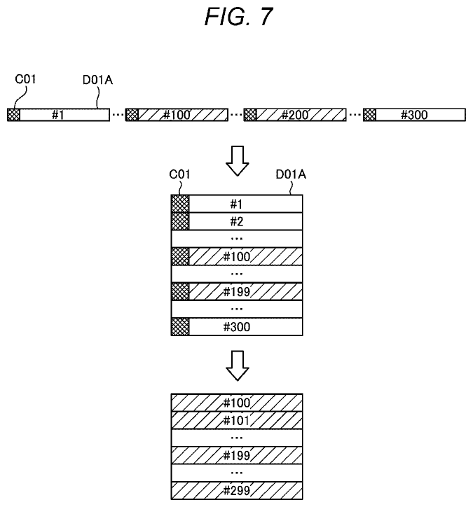

Subsequently, the image acquisition processing performed by the image capturing system will be described. To begin with, with reference to FIG. 7, as a comparative example, the image acquisition processing in the image capturing system in which only the line head code C01 is imparted will be described. FIG. 7 is a diagram for describing the image acquisition processing by the image capturing system according to the comparative example.

As shown in FIG. 7, the line sensor 100A of the image capturing system according to the comparative example imparts the line head code C01 to the acquired line data to generate output line data D01A. In FIG. 7, the line sensor 100A outputs the output line data D01A of 300 lines.

Upon acquiring the output line data D01A, to connect the output line data D01A vertically and display one image M on the display device 300A, the control device 200A generates display line data D02. At this time, the output line data D01A of the line sensor 100A includes valid data to be displayed on the display device 300A and invalid data not to be displayed on the display device 300A. In FIG. 7, the valid data is shown with diagonal lines.

Here, since the line sensor 100A imparts only the line head code C01 to the line data, the control device 200A cannot determine whether the output line data D01A is valid data or invalid data only by referring to the synchronizing code.

Therefore, the control device 200A refers to data included in the output line data D01A to determine whether or not the output line data D01A is valid data from the luminance value, edge detection, and the like.

Furthermore, since the frame head code C02 or the frame terminal code C12 is not imparted to the output line data D01A, the control device 200 refers to data included in the valid output line data D01A, performs edge detection and the like, and determines the output line data D01A that is the frame head from the acquired output line data D01A. In the example of FIG. 7, the control device 200A determines the line data #100, which is valid data, as the frame head.

Furthermore, the control device 200A determines the terminus of the frame according to the image size that can be displayed on the display device 300A. In the example of FIG. 7, the control device 200A determines the line data #299, which is valid data, as the frame terminus.

The control device 200A deletes the synchronizing code from the determined output line data D01A included in the frame to generate the display line data D02 for output to the display device 300A.

Next, with reference to FIG. 8, the image acquisition processing in the image capturing device according to the present embodiment will be described. FIG. 8 is a diagram for describing the image acquisition processing by the image capturing system according to the embodiment of the present disclosure.

The line sensor 100 imparts the synchronizing code to the acquired line data. In the example shown in FIG. 8, the line sensor 100 imparts the valid/invalid code C13 indicating invalid data to the head of the line data #1 and imparts the line terminal code C11 to the terminus to generate the output line data D01. Here, in a case where the line sensor 100 integrates the captured images of a plurality of pixel lines to acquire the line data, the line sensor 100 imparts the valid/invalid code C13 according to the integration amount. More specifically, in a case where the integration amount of the captured image is less than a predetermined number, the line sensor 100 imparts the valid/invalid code C13 indicating invalid data to the acquired line data. Furthermore, in a case where the integration amount of the captured image is the predetermined number, the line sensor 100 imparts the valid/invalid code C13 indicating valid data to the acquired line data. The line sensor 100 or the line sensor 100 imparts the frame head code C02 to the head of the line data #100 and imparts the line terminal code C11 to the terminus to generate the output line data D01. The line sensor 100 imparts the valid/invalid code C13 indicating valid data to the head of the line data #200 and imparts the line terminal code C11 to the terminus to generate the output line data D01. The line sensor 100 imparts the frame terminal code C12 to the head of the line data #300 and imparts the line terminal code C11 to the terminus to generate the output line data D01.

Note that FIG. 8 shows a case where the line sensor 100 imparts one synchronizing code to the head of the line data, but this is not restrictive. The line sensor 100 may impart two or more synchronizing codes to the head of the line data. For example, the line sensor 100 may impart the valid/invalid code C13, and the frame head code C02 or the frame terminal code C12 to the head of the same line data.

Furthermore, in FIG. 8, the line sensor 100 imparts either one of the frame head code C02, the frame terminal code C12, and the valid/invalid code C13 to the head of the line data. Therefore, in FIG. 8, the impartation of the line head code C01 indicating the head of the line data is omitted.

The control device 200 that has acquired the output line data D01 refers to the synchronizing code and discards, for example, the output line data D01 to which the valid/invalid code C13 indicating invalid data is imparted. The control device 200 determines, as one frame, data from the output line data D01 to which the frame head code C02 is imparted to the output line data D01 that is one data before the output line data D01 to which the frame terminal code C12 is imparted. Note that here, the output line data D01 to which the frame terminal code C12 is imparted is not included in the frame, but the output line data D01 to which the frame terminal code C12 is imparted may also be included in one frame.

The control device 200 deletes the synchronizing code of the determined output line data D01 included in the frame to generate the display line data for output to the display device 300.

### 3.2. Operation Example of Image Capturing System

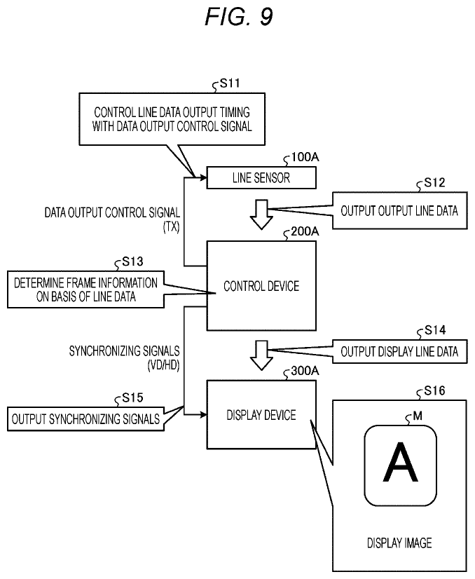

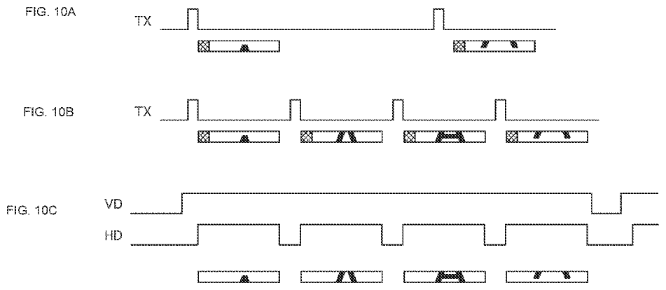

Subsequently, an operation example of the image capturing system will be described. To begin with, with reference to FIG. 9, the operation example of the image capturing system that imparts only the line head code C01 will be described as a comparative example. FIG. 9 is a diagram for describing the operation example of the image capturing system according to the comparative example.

As shown in FIG. 9, upon receipt of a data output control signal TX from the control device 200A, the line sensor 100A controls line data output timing with such a data output control signal TX (step S11). On the basis of the line data output timing, the line sensor 100A outputs the generated output line data D01 to the control device 200A (step S12).

On the basis of line data (pixel data) included in the output line data D01, the control device 200A determines frame information (step S13). More specifically, the control device 200A determines from where to where the output line data D01 is included in one frame.

The control device 200A generates display line data from the output line data D01, outputs the generated display line data to the display device 300A (step S14), and outputs synchronizing signals VD and HD to the display device 300A (step S15). The display device 300A displays the image M on the basis of the display line data and the synchronizing signals VD and HD (step S16).

Here, with reference to FIG. 10, the data output control signal TX and the synchronizing signals VD and HD generated by the control device 200A according to the comparative example will be described. FIG. 10 is a diagram for describing control signals generated by the control device 200A according to the comparative example. Here, the control signals generated by the control device 200A include the data output control signal TX and the synchronizing signals VD and HD.

The data output control signal TX shown in FIG. 10(a) is a control signal output by the control device 200A in a case where line data output timing is adjusted. The control device 200A determines the output timing of the output line data D01 while changing the output timing of the output line data D01. The control device 200A determines whether or not the pixel values are continuous by, for example, performing edge detection on the line data of the output line data D01 continuously acquired, and the like. In a case where the pixel values are not continuous, the control device 200A changes the output timing of the output line data D01 and determines the output timing such that the edge is continuous.

By adjusting the line data output timing in this way, the control device 200A can display the image M of a size equal to or greater than the vertical size V2 of the image capturing unit 110A on the display device 300A. Note that such an adjustment is made, for example, when the image capturing system is introduced or when the image capturing system is started.

FIG. 10(b) is a diagram showing the data output control signal TX after adjusting the line data output timing. As shown in FIG. 10(b), the adjusted data output control signal TX repeatedly becomes high at predetermined intervals, and the line sensor 100A outputs the output line data D01, for example, in synchronization with the falling edge of the data output control signal TX.

FIG. 10(c) is a diagram showing the synchronizing signals VD and HD. The synchronizing signal VD shown in FIG. 10(c) is a signal indicating the synchronization timing in the vertical direction. The display line data included in the high period is the line data included in one frame. Furthermore, the synchronizing signal HD is a signal indicating the synchronization timing in the horizontal direction. The display line data included in the high period is the line data displayed on the display device 300A as one line.

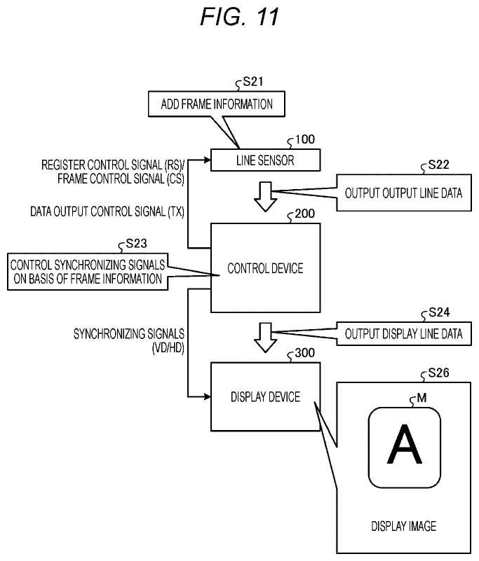

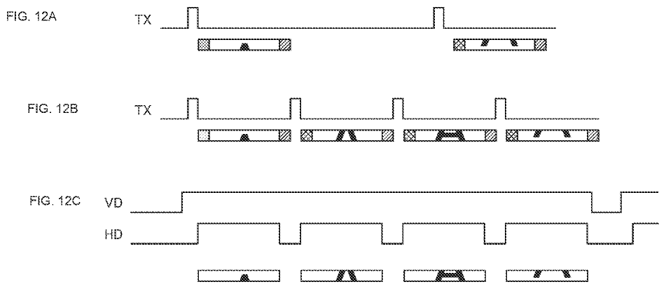

Next, with reference to FIG. 11, an operation example of the image capturing system according to the embodiment of the present disclosure will be described. FIG. 11 is a diagram for describing the operation example of the image capturing system according to the embodiment of the present disclosure.

As shown in FIG. 11, the line sensor 100A adds a synchronizing code including frame information (for example, frame head code C02) to the line data to generate the output line data D01 (step S21). The frame information is imparted on the basis of a frame control signal CS output by the control device 200 or the state of the STB register 121. Note that the state of the STB register 121 changes, for example, on the basis of a register control signal RS output by the control device 200. The line sensor 100 outputs the generated output line data D01 to the control device 200 on the basis of the data output control signal TX (step S22).

The control device 200 controls the synchronizing signal VD on the basis of the frame information obtained by referring to the synchronizing code (step S23).

The control device 200 generates the display line data from the output line data D01, outputs the generated display line data to the display device 300 (step S24), and outputs the synchronizing signals VD and HD to the display device 300 (step S25). The display device 300 displays the image M on the basis of the display line data and the synchronizing signals VD and HD (step S26).

The control device 200 can control the synchronizing signal VD in step S23 by just referring to the synchronizing code without referring to the pixel values of the line data. In this way, the processing load of the control device 200 can be reduced.

Note that here, the control device 200 is supposed to control the STB register 121 by using the register control signal RS, but this is not restrictive. For example, the control device 200 may control the STB register 121 directly via a communication IF without using the register control signal RS.

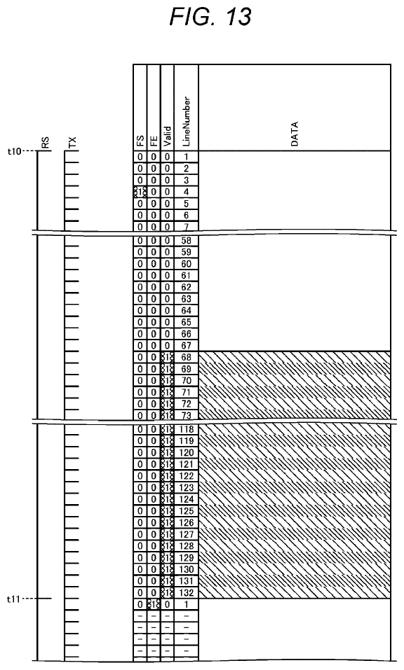

Here, with reference to FIG. 12, the data output control signal TX and the synchronizing signals VD and HD generated by the control device 200 according to the present embodiment will be described. FIG. 12 is a diagram for describing the control signals generated by the control device 200 according to the embodiment of the present disclosure. Here, the control signals generated by the control device 200 include the data output control signal TX and the synchronizing signals VD and HD.

The data output control signal TX shown in FIG. 12(a) is a control signal output by the control device 200 in a case where line data output timing is adjusted. The control device 200 determines the output timing of the output line data D01 while changing the output timing of the output line data D01. The control device 200 determines whether or not the pixel values are continuous by, for example, performing edge detection on the line data of the output line data D01 continuously acquired, and the like. In a case where the pixel values are not continuous, the control device 200 changes the output timing of the output line data D01 and determines the output timing such that the edge is continuous.

Furthermore, the control device 200 determines the output line data D01 to be the head of the frame by performing edge detection on the output line data D01, and the like.

By adjusting the line data output timing in this way, the control device 200 can display the image M of a size equal to or greater than the vertical size V2 of the image capturing unit 110 on the display device 300. Furthermore, the control device 200 can determine the head of the frame. Note that such an adjustment is made, for example, when the image capturing system is introduced or when the image capturing system is started. Furthermore, the control device 200 can determine the terminus of the frame by determining the head of the frame. The control device 200 determines, for example, the number of valid output line data DO1 required for one frame from the head of the frame according to the image size to be displayed on the display device 200. In a case where the determined number of valid output line data D01 is acquired, the control device 200 can determine that the output line data D01 has been acquired to the terminus of the frame. In this way, the frame size is determined according to the size of the image M displayed on the display device 300.

FIG. 12(b) is a diagram showing the data output control signal TX after adjusting the line data output timing. As shown in FIG. 12(b), the adjusted data output control signal TX repeatedly becomes high at predetermined intervals, and the line sensor 100 outputs the output line data D01, for example, in synchronization with the falling edge of the data output control signal TX.

FIG. 12(c) is a diagram showing the synchronizing signals VD and HD. The synchronizing signal VD shown in FIG. 12(c) is a signal indicating the synchronization timing in the vertical direction. The display line data included in the high period is the line data included in one frame. Furthermore, the synchronizing signal HD is a signal indicating the synchronization timing in the horizontal direction. The display line data included in the high period is the line data displayed as one line on the display device 300.

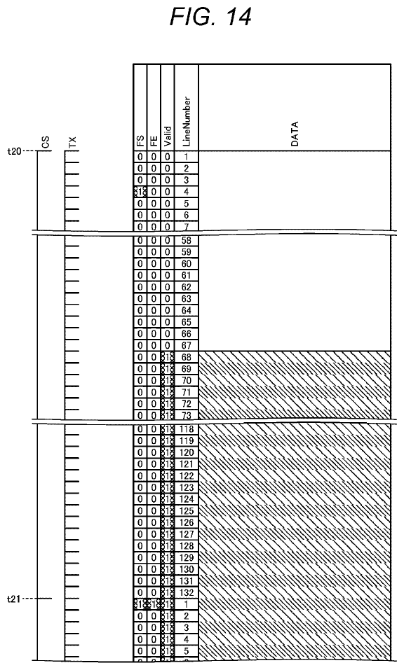

Next, with reference to FIG. 13, the register control signal RS output by the control device 200 to control the STB register 121 will be described. FIG. 13 is a diagram for describing the register control signal RS generated by the control device 200 according to the embodiment of the present disclosure.

FIG. 13 shows one example of the register control signal RS, the data output control signal TX, and the output line data D01.

Here, the register control signal RS is a signal to shift the state of the line sensor 100. More specifically, if the register control signal RS that is high is input into the line sensor 100, the STB register 121 is canceled or set, and the state of the line sensor 100 makes a transition from the standby state to the active state or from the active state to the standby state. By using the register control signal RS, the control device 200 directly cancels/sets the STB register 121 of the storage unit 120 via the communication I/F 140. In other words, the control device 200 can directly write the STB register 121 by using the register control signal RS.

Furthermore, the data output control signal TX is a signal instructing the output timing of the output line data D01 as described above, and the line sensor 100 outputs the output line data D01 in synchronization with the data output control signal TX.

The output line data D01 shown in FIG. 13 includes, as a header, a frame start (FS) corresponding to the frame head code C02 and indicating the head of the frame, and a frame end (FE) corresponding to the frame terminal code C12 and indicating the terminus of the frame. Furthermore, the header includes, for example, valid (corresponding to the valid/invalid code C13) indicating valid/invalid of the line data. The header is imparted to the head of DATA (corresponding to the line data).

Although illustration is omitted in FIG. 13, the line terminal code indicating the line terminus is imparted after DATA as a footer.

If the line sensor 100 starts, the STB register 121 is set (for example, “1” is written), and the state of the line sensor 100 becomes the standby state.

Thereafter, as shown in FIG. 13, if the register control signal RS input from the control device 200 becomes high at time t10, the STB register 121 is canceled (for example, “0” is written), and the state of the line sensor 100 makes a transition from the standby state to the active state.

Furthermore, the data output control signal TX that becomes high in a predetermined cycle is input from the control device 200. Upon making a transition to the active state at time t10, the line sensor 100 outputs the output line data D01 sequentially in synchronization with the data output control signal TX.

Note that since the status of the line sensor 100 makes a transition from the standby state to the active state, various control values of the line sensor 100 are initialized. For example, the output line data D01 whose LineNumber is “4” or later includes the line data captured by the image capturing unit 110. In this case, assuming that the output line data D01 of LineNumber=4 where the image capturing unit 110 starts capturing of the line data is the head of the frame, the line sensor 100 sets the FS of the output line data D01 to FS=1. Note that FS=1 indicates that the output line data D01 is the head of the frame, and FS=0 indicates that the output line data D01 is not the head of the frame.

Furthermore, in a case where a predetermined number of line data is captured after the image capturing unit 110 starts capturing, the line sensor 100 determines that the line data is valid, and sets Valid to Valid=1. Note that Valid=1 indicates that the output line data D01 is valid, and Valid=0 indicates that the output line data D01 is invalid.

Upon acquiring the number of output line data D01 required to display on the display device 300 from the line sensor 100, the control device 200 outputs the register control signal RS that is high and sets the STB register 121. With this operation, the state of the line sensor 100 makes a transition from the active state to the standby state. In FIG. 13, at time t11, the control device 200 outputs the register control signal RS that is high. The line sensor 100 that has received the register control signal RS that is high at time t11 outputs the output line data D01 of one frame and sets the FE of the output line data D01 to be output next to FE=1. Note that FS=1 indicates that the output line data D01 is the terminus of the frame, and FS=0 indicates that the output line data D01 is not the terminus of the frame.

In this way, since the control device 200 uses the register control signal RS to cause the state of the line sensor 100 to make a transition, the line sensor 100 can determine the start and end of the frame, and can impart the synchronizing code indicating the start and end of the frame to the line data.

This allows the control device 200 to determine the start and end of the frame without referring to the data in the output line data D01, and to suppress the processing load of the control device 200.

Note that the control device 200 determines the start timing of the first frame, for example, when adjusting the output timing of the line data described above. Furthermore, the control device 200 may determine the end timing of the first frame, for example, according to the number of acquisitions of valid line data included in the first frame. That is, the control device 200 determines to finish the first frame at the timing when the line data of the number of lines to be displayed on the display device 300 is acquired after the first frame is started. By determining the start and end timing of the second and subsequent frames in a similar way, the control device 200 can determine the frame information from the data of the output line data D01 without performing processing such as edge detection.

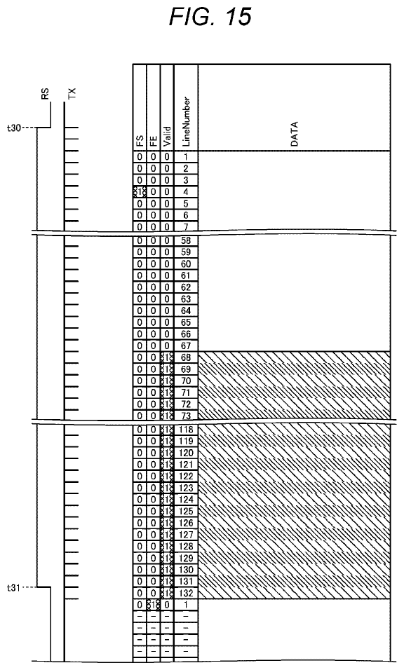

Next, with reference to FIG. 14, the frame control signal CS according to the embodiment of the present disclosure will be described. Note that the control device 200 controls the frame of the output line data output by the line sensor 100 by using either the register control signal RS or the frame control signal CS described above. FIG. 14 is a diagram for describing the frame control signal CS generated by the control device 200 according to the embodiment of the present disclosure.

The output line data and the data output control signal TX shown in FIG. 14 are the same as the signals in FIG. 13, and therefore detailed description thereof will be omitted. The frame control signal CS shown in FIG. 14 is input, for example, from the control device 200 to the line sensor 100 via an external terminal XVS (not shown).

The control device 200 inputs the frame control signal CS that is high to the line sensor 100 at time t20 when the data output control signal TX that is high is input a predetermined number of times (4 times in FIG. 14) after the line sensor 100 is started. If the frame control signal CS that is high is input, the line sensor 100 outputs the output line data D01 of FS=1, assuming the head of the frame.

Note that in FIG. 14, at the timing when the frame control signal CS first becomes high, the line sensor 100 becomes the active state and the capturing is started. Therefore, the timing when the frame starts (timing when FS=1) is later than the timing when the frame control signal CS first becomes high.

Furthermore, upon acquiring the number of output line data D01 required to display on the display device 300 from the line sensor 100, the control device 200 outputs the frame control signal CS. With this operation, the line sensor 100 determines the start and end of the frame, and changes the values of FS or FE indicating the start or end of the frame.

Since the line sensor 100 moves to the next frame without resetting the logic internal sequence control (control to be performed by the control unit 130 to acquire the line data), the synchronizing code indicating the start and end of the frame is imparted to the same output line data. Note that in this case, the impartation of the synchronizing code indicating the end of the frame may be omitted.

In this way, since the control device 200 uses the frame control signal CS to designate the start and end timing of the frame, the line sensor 100 can also impart the frame information to the line data.

In a case where the above-described register control signal RS is a high signal, the STB register 121 is set or canceled, but this is not restrictive. For example, in a case where the register control signal RS is a high signal, the line sensor 100 may be set to the standby state, and in a case where the register control signal RS is a low signal, the line sensor 100 may be set to the active state. In this case, for example, in a case where the register control signal RS is a high signal, “1” is written in the STB register 121, and in a case where the register control signal RS is a low signal, “0” is written in the STB register 121. With this arrangement, the state of the line sensor 100 makes a transition. Such a case will be described below with reference to FIG. 15. FIG. 15 is a diagram for describing another example of the register control signal RS generated by the control device 200 according to the embodiment of the present disclosure.

As shown in FIG. 15, after starting the line sensor 100, the control device 200 inputs the register control signal RS that switches from high to low at time t30 into the line sensor 100. With this operation, the line sensor 100 switches from the standby state to the active state. Thereafter, at the timing when the data output control signal TX input by the control device 200 becomes high a predetermined number of times, the line sensor 100 outputs the output line data D01 to which the synchronizing code is imparted. Furthermore, assuming that the timing when the output line data D01 is output a predetermined number of times (4 times in FIG. 15) in synchronization with the data output control signal TX is the head of the frame, the line sensor 100 outputs the output line data D01 of FS=1.

Furthermore, upon acquiring the number of output line data D01 required to display on the display device 300 from the line sensor 100, the control device 200 switches the register control signal RS from low to high. With this operation, the line sensor 100 determines the end of the frame, next outputs the output line data D01 with the changed value of FE indicating the end of the frame at the timing of synchronizing with the data output control signal TX, and moves to the standby state.

In this way, by controlling the STB register at the timing of rising and falling of the register control signal RS, the control device 200 can also designate the timing of start and end of the frame.

### 3.3. Operation Example of Line Sensor

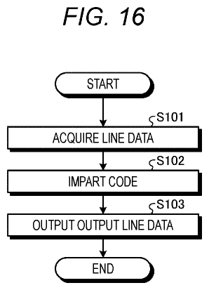

Next, with reference to FIG. 16, an operation example of the line sensor 100 according to the embodiment of the present disclosure will be described. FIG. 16 is a flowchart showing one example of line data output processing by the line sensor 100 according to the embodiment of the present disclosure.

As shown in FIG. 16, the line sensor 100 acquires the line data on the basis of the captured image captured by the image capturing unit 110 (step S101).

The line sensor 100 imparts the synchronizing code to the acquired line data (step S102). The line sensor 100 imparts, for example, the synchronizing code indicating the head of the frame (additional information) to the line data of the head of the frame. With this operation, the line sensor 100 generates the output line data D01 including the frame information.

The line sensor 100 outputs the generated output line data D01 to the control device 200 (step S103).

With this operation, the line sensor 100 can output the output line data D01 including the frame information to the control device 200. The control device 200 displays the line data on the display device 300 on the basis of the frame information, thereby reducing the processing load.

### 4. Supplement

The preferred embodiment of the present disclosure has been described in detail above with reference to the accompanying drawings, but the technical scope of the present disclosure is not limited to such an example. It is obvious that persons of ordinary skill in the technical field of the present disclosure can conceive various modifications or alterations within the scope of the technical idea described in the claims, and it is of course understood that these also fall within the technical scope of the present disclosure.

Out of the processing described in the embodiment, all or part of the processing described as being automatically performed can also be performed manually. Alternatively, all or part of the processing described as being performed manually can be automatically performed by a known method. In addition, information including processing procedures shown in the above documents and drawings, specific names, various data and parameters can be changed arbitrarily unless otherwise specified. For example, various information items shown in each figure is not limited to the information shown in the figure.

Furthermore, each component of each of the illustrated devices is a functional concept, and does not necessarily have to be physically configured as shown in the figure. That is, the specific form of distribution or integration of each device is not limited to the one shown in the figure, and all or part thereof can be functionally or physically distributed or integrated in an arbitrary unit depending on various loads, use situations, and the like.

Furthermore, the above-described embodiment can be appropriately combined as long as details of the processing do not contradict each other.

Furthermore, effects described in the present specification are merely descriptive or illustrative and not restrictive. That is, the technology according to the present disclosure can produce other effects obvious to those skilled in the art from the description in the present specification, in addition to or instead of the effects described above.

Note that the following configurations also belong to the technical scope of the present disclosure.

(1)

An image capturing device including:

an image capturing unit extending straight in a longitudinal direction;

an acquisition unit that acquires line data from the image capturing unit;

an additional information imparting unit that imparts first additional information to the line data that is a head line of a frame out of a plurality of the line data to generate output line data; and

an output unit that outputs the output line data.

(2)

The image capturing device according to (1), in which the additional information imparting unit imparts second additional information to the line data that is a terminal line of the frame to generate the output line data.

(3)

The image capturing device according to (2), in which the additional information imparting unit imparts at least one of the first additional information or the second additional information on the basis of a control signal from a control device.

(4)

The image capturing device according to (3), in which the control signal includes a signal designating at least one of the head line or the terminal line of the frame.

(5)

The image capturing device according to (3), in which the control signal is a signal instructing the image capturing device to cancel or set a standby state.

(6)

The image capturing device according to any one of (1) to (5), in which the additional information imparting unit imparts third additional information indicating whether or not the line data is valid data.

(7)

The image capturing device according to (6), in which

the acquisition unit acquires the line data by integrating a captured image captured by the image capturing unit, and

the additional information imparting unit imparts the third additional information to the line data according to an integration amount of the captured image.

(8)

The image capturing device according to any one of (1) to (7), in which in the frame, a terminal line is determined according to a size of an image displayed on a display device.

(9)

An image capturing system including:

an image capturing device;

a display device that displays a captured image captured by the image capturing device; and

a control device that controls the image capturing device and the display device,

in which

the image capturing device includes:

an image capturing unit extending straight in a longitudinal direction;

an acquisition unit that acquires line data from the image capturing unit;

an additional information imparting unit that imparts first additional information to the line data that is a head line of a frame out of a plurality of the line data to generate output line data; and

an output unit that outputs the output line data.

(10)

An image capturing method including:

acquiring line data from an image capturing unit extending straight in a longitudinal direction;

imparting first additional information to the line data that is a head line of a frame out of a plurality of the line data to generate output line data; and

outputting the output line data.

### REFERENCE SIGNS LIST

100 Line sensor

110 Image capturing unit

120 Storage unit

130 Control unit

131 Acquisition unit

132 Code imparting unit

133 Output control unit

140 Communication I/F

200 Control device

300 Display device

1. An image capturing device comprising:
an image capturing unit extending straight in a longitudinal direction;
an acquisition unit that acquires line data from the image capturing unit;
an additional information imparting unit that imparts first additional information to the line data that is a head line of a frame out of a plurality of the line data to generate output line data; and
an output unit that outputs the output line data.

2. The image capturing device according to claim 1, wherein the additional information imparting unit imparts second additional information to the line data that is a terminal line of the frame to generate the output line data.

3. The image capturing device according to claim 2, wherein the additional information imparting unit imparts at least one of the first additional information or the second additional information on a basis of a control signal from a control device.

4. The image capturing device according to claim 3, wherein the control signal includes a signal designating at least one of the head line or the terminal line of the frame.

5. The image capturing device according to claim 3, wherein the control signal is a signal instructing the image capturing device to cancel or set a standby state.

6. The image capturing device according to claim 1, wherein the additional information imparting unit imparts third additional information indicating whether or not the line data is valid data.

7. The image capturing device according to claim 6, wherein
the acquisition unit acquires the line data by integrating a captured image captured by the image capturing unit, and
the additional information imparting unit imparts the third additional information to the line data according to an integration amount of the captured image.

8. The image capturing device according to claim 1, wherein in the frame, a terminal line is determined according to a size of an image displayed on a display device.

9. An image capturing system comprising:
an image capturing device;
a display device that displays a captured image captured by the image capturing device; and
a control device that controls the image capturing device and the display device,
wherein
the image capturing device includes:
an image capturing unit extending straight in a longitudinal direction;
an acquisition unit that acquires line data from the image capturing unit;
an additional information imparting unit that imparts first additional information to the line data that is a head line of a frame out of a plurality of the line data to generate output line data; and
an output unit that outputs the output line data.

10. An image capturing method comprising:
acquiring line data from an image capturing unit extending straight in a longitudinal direction;
imparting first additional information to the line data that is a head line of a frame out of a plurality of the line data to generate output line data; and
outputting the output line data.
